(19) United States
(12) Patent Application Publication
(10) Pub. No.: US 2013/0238687 A1
(43) Pub. Date: Sep. 12, 2013

(54) INFORMATION PROCESSING APPARATUS AND CLIENT MANAGEMENT METHOD

(71) Applicant: Takumi Yamashita, Hamura-shi (JP)

(72) Inventor: Takumi Yamashita, Hamura-shi (JP)

(21) Appl. No.: 13/609,718

(22) Filed: Sep. 11, 2012

(30) Foreign Application Priority Data
Mar. 9, 2012 (JP) 2012-052924

(51) Int. Cl. G06F 15/16

(52) U.S. Cl. 709/203

(57) ABSTRACT

According to one embodiment, an information processing apparatus is applied to a client management system which manages first-type clients and second-type clients. The apparatus includes an information generator and a delivery controller. The information generator generates delivery group information including at least one of client member indicating a first client of the first-type clients and user member indicating a user who uses one of the second-type clients, wherein the first client executes virtualization software. The delivery controller delivers a disk image to the first client if the client member is in the delivery group information, and delivers the disk image to an execution server if the user member is in the delivery group information.

### CROSS-REFERENCE TO RELATED APPLICATIONS

This application is based upon and claims the benefit of priority from Japanese Patent Application No. 2012-052924, filed Mar. 9, 2012, the entire contents of which are incorporated herein by reference.

### FIELD

Embodiments described herein relate generally to an information processing apparatus which manages a client terminal, and a client management method applied to the apparatus.

### BACKGROUND

In recent years, in various kinds of companies, a system (client management system) for managing, by a server, many client terminals in offices has been introduced.

In the client management system, the desktop environments (operating systems, applications) of many client terminals can be centrally managed by a server in the client management system. By the central management, many client terminals can efficiently be managed.

In the client management system, in some cases, such a method is adopted that all client terminals are not individually managed, but the client terminals, for example, are divided into some groups and the client terminals are managed in units of a group. In this method, for example, different operations can be performed in the individual groups, and administrators can be assigned to the individual groups.

In the meantime, in some cases, as the above-described client terminals, use is made of not only rich client terminals such as personal computers, but also thin client terminals. In the server, for example, an OS and an application program, which are used in a rich client terminal, and an OS and an application program, which are used in a thin client terminal, are separately managed. However, when a common OS and application are used in the rich client terminal and thin client terminal, such separate management of the OS and application program, according to the kinds of terminals, increases the cost for management and is troublesome for an administrator.

### BRIEF DESCRIPTION OF THE DRAWINGS

A general architecture that implements the various features of the invention will now be described with reference to the drawings. The drawings and the associated descriptions are provided to illustrate the embodiments and not to limit the scope of the invention.

FIG. 1 is an exemplary conceptual view for describing the delivery of disk images by a client management system including an information processing apparatus (disk image delivery server) according to an embodiment.

FIG. 2 is an exemplary block diagram illustrating the system configuration of the client management system of FIG. 1.

FIG. 3 is an exemplary block diagram illustrating the functional configuration of the client management system of FIG. 1.

FIG. 4 is an exemplary view for explaining groups to which client terminals, which are managed by the client management system of FIG. 1, belong.

FIG. 5 is an exemplary view illustrating a configuration example of group information which is used by the information processing apparatus of the embodiment.

FIG. 6 is an exemplary view illustrating a configuration example of user information which is used by the information processing apparatus of the embodiment.

FIG. 7 is an exemplary view illustrating a configuration example of client information which is used by the information processing apparatus of the embodiment.

FIG. 8 is an exemplary view illustrating a configuration example of disk image information which is used by the information processing apparatus of the embodiment.

FIG. 9 is an exemplary view illustrating a configuration example of delivery group information which is used by the information processing apparatus of the embodiment.

FIG. 10 is an exemplary view illustrating an example of a delivery group setup screen displayed by the information processing apparatus of the embodiment.

FIG. 11 is an exemplary view illustrating an example of a delivery image setup screen displayed by the information processing apparatus of the embodiment.

FIG. 12 is an exemplary view illustrating another example of the delivery group setup screen displayed by the information processing apparatus of the embodiment.

FIG. 13 is an exemplary view illustrating another configuration example of the delivery group information which is used by the information processing apparatus of the embodiment.

FIG. 14 is an exemplary flowchart illustrating an example of the procedure of a delivery information generation process executed by the information processing apparatus of the embodiment.

FIG. 15 is an exemplary flowchart illustrating an example of the procedure of a delivery control process executed by the information processing apparatus of the embodiment.

### DETAILED DESCRIPTION

Various embodiments will be described hereinafter with reference to the accompanying drawings.

In general, according to one embodiment, an information processing apparatus is applied to a client management system which is configured to manage first-type client terminals and second-type client terminals on a network. The information processing apparatus includes a file generator, an information generator and a delivery controller. The file generator is configured to generate a disk image file including an operating system and an application program. The information generator is configured to generate delivery group information including at least one of client member information and user member information, wherein the client member information indicates a first terminal of the first-type client terminals, the first terminal is configured to execute virtualization software and the operating system and the application program in the disk image file, and the user member information indicates a user who uses the operating system and the application program by using any one of the second-type client terminals. The delivery controller is configured to deliver the disk image file to the first terminal if the client member information is included in the delivery group information, and to deliver the disk image file to an execution server if the user member information is included in the delivery group information, wherein the execution server is configured to execute a virtual machine configured to communicate with each of the second-type client terminals by using a screen transfer protocol.

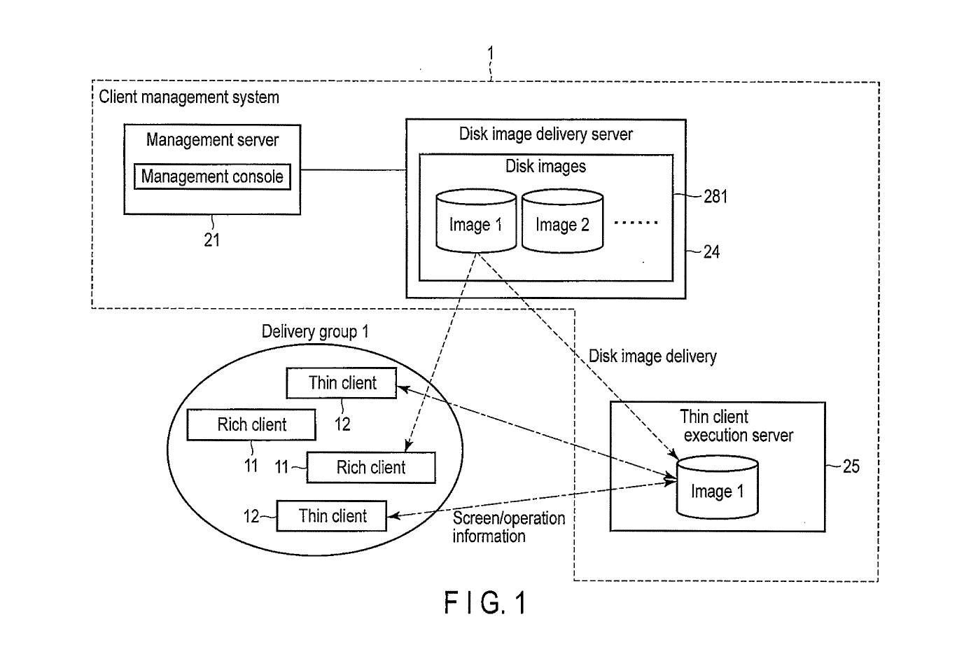

To begin with, referring to FIG. 1, a description is given of the delivery of disk images 281 by a client management system 1 including an information processing apparatus according to an embodiment. The client management system 1 is a server system for managing a plurality of client terminals (client computers). The client management system 1 can be realized by one or more servers (physical servers). In this example, it is assumed that the client management server 1 is realized by a plurality of servers.

The client management system 1 includes a management server 21, a disk image delivery server 24 and a thin client execution server 25. The management server 21, disk image delivery server 24 and thin client execution server 25 are connected to a network such as a local area network (LAN). A plurality of first-type client terminals 11 and a plurality of second-type client terminals 12 are also connected to the above-described network.

The client management system 1 is disposed, for example, in an office. The client management system 1 centrally manages, by the management server 21, a plurality of client terminals disposed in the office. The management server 21 also manages users who use the client terminals, groups to which the client terminals belong, and groups to which the users belong. In addition, the management server 21 alters information for managing the above-described client terminals, users and groups, for example, in accordance with an operation by an administrator with use of a management console. Besides, the client management system 1 manages, by the disk image delivery server 24, the delivery of the disk images 281 including operating systems (OS) and application programs which are used in the client terminals.

In the present embodiment, the client management system 1 can manage two types of client terminals, namely first-type client terminals and second-type client terminals. The client terminals 11 shown in FIG. 1 are first-type client terminals. The first-type client terminal 11 is a so-called virtualization client terminal. A virtual machine monitor (hypervisor) is installed as virtualization software in a local storage of the first-type client terminal 11. The first-type client terminal 11 executes the virtualization software, and an OS and an application program in a virtual image file which is delivered from the system 1. The first-type client terminal 11 is realized, for example, as a personal computer, and is also called “rich client terminal”.

The second-type client terminals are thin client terminals. Using a screen transfer protocol, these thin client terminals 12 communicate with virtual machines, respectively, which are executed on the thin client execution server 25 in the system 1. In other words, the plural thin client terminals 12 are terminals (base terminals) for realizing desktop virtualization by using a virtual desktop infrastructure (VDI). The desktop environments (OS's, applications) of these thin client terminals 12 are centrally managed by the thin client execution server 25 which is a virtualization server. One of virtual machines on the thin client execution server 25 is assigned to each thin client terminal 12. The OS and application are executed, not on the thin client terminal 12, but on the virtual machine of the thin client execution server 25.

Each thin client terminal 12 transmits input information, which corresponds to an operation by a user of an input device (e.g. keyboard, mouse), to the assigned virtual machine in the thin client execution server 25. In addition, each thin client terminal 12 receives screen information, in which the input information is reflected, from the assigned virtual machine in the thin client execution server 25.

As described above, the operating systems, application programs, data, etc., which are used in the thin client terminals 12, are centrally managed by the thin client execution server 25. Thus, by using the thin client terminals, the operational cost and the risk on security can be reduced.

In addition, it is assumed that the thin client terminals 12 are used, for example, in a mode called “free address office”. In the free address office, a thin client terminal 12, which is used by a user, is not designated, and no matter which thin client terminal 12 the user uses, the user can work in the same desktop environment.

On the other hand, in many cases, the rich client terminal 11 includes resources of higher capabilities than the thin client terminal 12. Thus, for example, as regards business operations which involve processes with large amounts of calculations, such business operations can efficiently be performed by using the rich client terminal 11. In addition, it is assumed that a rich client terminal 11, which is used by a certain user, is designated. In other words, a certain rich client terminal 11 is used as a dedicated terminal for a user. Thus, the thin client terminal 12 and rich client terminal 11 are selectively used, depending on purposes or usages.

However, there is a case in which the OS and application, which are used in the client terminals 11 and 12, are common, regardless of the types of the client terminals. For example, it is assumed that the same OS and application program are used in client terminals in a group (management group), such as a department in a company, regardless of whether the client terminals are rich client terminals 11 or thin client terminals 12.

In the present embodiment, in order to manage the desktop environments (OS's, applications) of the client terminals 11 and 12, the disk image 281 including the OS and application is delivered. Accordingly, when the same desktop environment is used in the rich client terminal 11 and thin client terminal 12, one disk image 281 for this desktop environment is generated, and this one disk image 281 is delivered to the rich client terminal 11 and thin client execution server 25.

Specifically, the disk image delivery server 24 is the information processing apparatus of the present embodiment, and is applied to the client management system 11, for example, in order to manage the disk image file (virtual image file) 281. The disk image delivery server 24 may be realized by a single physical server.

The disk image delivery server 24 delivers the disk image 281 to the first-type client terminal (rich client terminal) 11 and the thin client execution server 25. The disk image delivery server 24 delivers, to individual delivery groups, disk images 281 which are assigned to these individual delivery groups. For example, as illustrated in FIG. 1, the disk image delivery server 24 delivers a first disk image, which is associated with “delivery group 1”, to a rich client terminal 11 which belongs to the “delivery group 1”, and to the thin client execution server 25 including virtual machines that are assigned to thin client terminals 12. Thereby, the user of the rich client terminal 11 belonging to the “delivery group 1” can use the OS and application program in the first disk image. In addition, the user belonging to the “delivery group 1” can use, with use of the thin client terminal 12, the OS and application program in the first disk image, which are executed by the virtual machine on the thin client execution server 25.

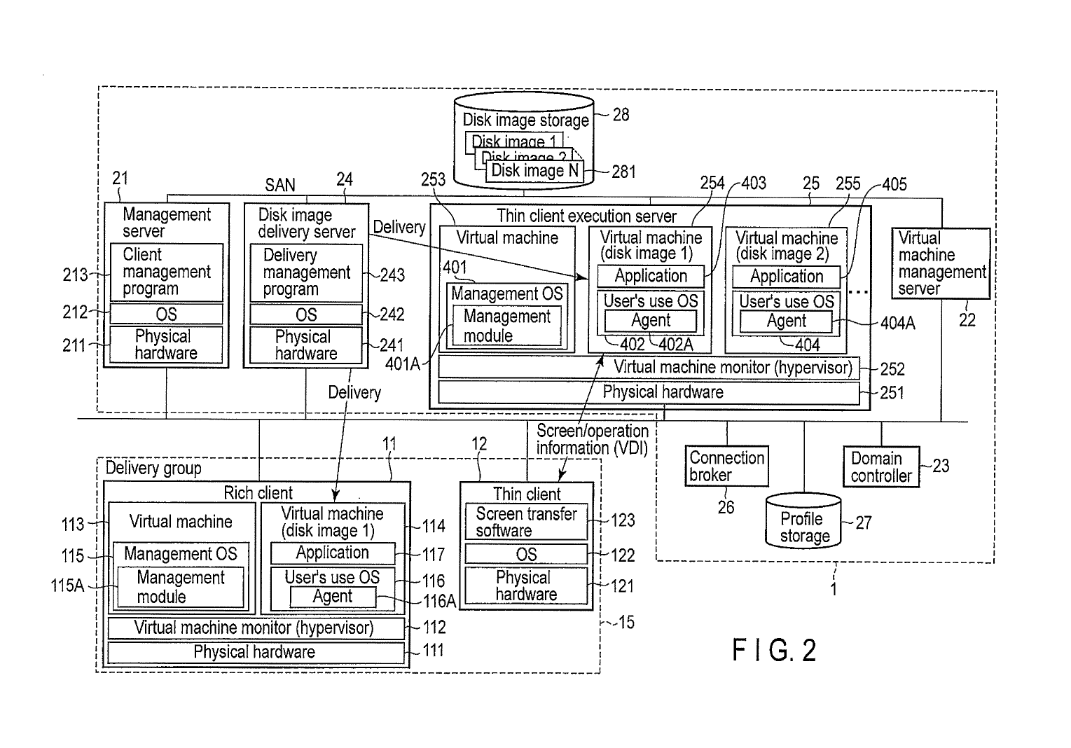

FIG. 2 shows the configuration of the client management system 1. The client management system 1 includes a management server 21, a virtual machine management server 22, a domain controller 23, a disk image delivery server 24, a thin client execution server 25, a connection broker 26, a profile storage 27, and a disk image storage 28.

The management server 21, virtual machine management server 22, domain controller 23, disk image delivery server 24, thin client execution server 25, connection broker 26, and profile storage 27 are connected to a network, for instance, a LAN. A plurality of first-type client terminals (rich clients) 11 and a plurality of second-type client terminals (thin clients) 12 are also connected to the network, for instance, a LAN.

Further, the management server 21, virtual machine management server 22, disk image delivery server 24, and thin client execution server 25 are also connected to the disk image storage 28 via another network such as a storage area network (SAN).

In the first-type client terminal (rich client terminal) 11, a virtual machine monitor 112 is executed on physical hardware 111 such as a CPU, a memory, a storage and various I/O devices. The virtual machine monitor 112 is virtualization software such as a hypervisor, and functions as a virtualization layer on the physical hardware 111 by emulating resources of the physical hardware 111. Some virtual machines are executed on the virtual machine monitor 112 that functions as the virtualization layer. In FIG. 1, it is assumed that two virtual machines 113 and 114 are executed on the virtual machine monitor 112. The virtual machine 113 executes a management OS (host OS). On the other hand, the virtual machine 114 executes a user's use OS (guest OS) 116 and an application program 117 in a disk image file 281 which is delivered from the system 1. The virtual machine 114, that is, the user's use OS (guest OS) 116 and application program 117, operates as a desktop environment of the rich client terminal 11.

The management OS (host OS) 115 controls the virtual machine 114 in cooperation with the virtual machine monitor 112. The management OS (host OS) 115 includes a management module 115A. The management module 115A downloads the disk image file 281 from the disk image delivery server 24 in the system 1. The user's use OS (guest OS) 116 includes an agent 116A. The agent 116 is a program which executes a process of enabling cooperation between the system 1 and the rich client terminal 11.

In the second-type client terminal (thin client terminal) 12, screen transfer software 123 is executed. The screen transfer software 123 is a program which communicates with a virtual machine in the thin client execution server 25 by using a screen transfer protocol. The screen transfer software 123 may be an application program which operates on the OS. In this case, in the thin client terminal 12, an OS 122 is executed on physical hardware 121 such as a CPU, a memory and various I/O devices, and the screen transfer software 123 is executed on the OS 122.

Next, the respective components of the client management system 1 are described.

The management server 21 is a server for managing the operation of the client management system 1. In the management server 21, an OS 212 is executed on physical hardware 211 such as a CPU, a memory and various I/O devices, and a client management program 213 is executed on the OS 212. In accordance with an operation from an administrator terminal (management console), not shown, which is connected to the LAN, the management server 213 executes management of each user who can use the client management system 1, management of the rich client terminals 11, management of groups to which users belong, and management of groups to which the rich client terminals 11 belong.

The virtual machine management server 22 is a server for managing the thin client execution server 25. The domain controller 23 is a server for authenticating each user and each client terminal.

The disk image delivery server 24 manages disk image files 281 delivered to the rich client terminals 11 and the thin client execution server 25. As described above, each of disk image files 281 includes an OS and an application program. In the disk image delivery server 24, an OS 242 is executed on physical hardware 241 such as a CPU, a memory and various I/O devices, and a delivery management program 243 is executed on the OS 242. The delivery management program 243 generates a disk image file 281 for the rich client terminal 11 and thin client terminal 12. The disk image file 281 is delivered to the rich client terminal 11 to which this disk image file 281 is assigned, and to the thin client execution server 25. Each disk image file 281 is, for instance, a virtual image file of a virtual hard disk (VHD) format.

The thin client execution server 25 is a server which executes a plurality of virtual machines for communicating with the plural thin client terminals 12 by using the screen transfer protocol. The thin client execution server 25 may be realized, for example, by a physical server virtualized with use of a server virtualization technique.

In the thin client execution server 25, a virtual machine monitor 252 is executed on physical hardware 251 such as a CPU, a memory, a storage and various I/O devices. The virtual machine monitor 252 is virtualization software such as a hypervisor, and functions as a virtualization layer on the physical hardware 251 by emulating resources of the physical hardware 251. A virtual machine 253 for management and a plurality of virtual machines 254 and 255 for executing virtual desktop environments are executed on the virtual machine monitor 252. The virtual machine 253 executes a management OS (host OS) 401. On the other hand, the virtual machine 254 executes a user's use OS (guest OS) 402 and an application program 403 in a first disk image file 281 which is delivered from the disk image delivery server 24. In addition, the virtual machine 255 executes a user's use OS (guest OS) 404 and an application program 405 in a second disk image file 281 which is delivered from the disk image delivery server 24.

The management OS (host OS) 401, in cooperation with the virtual machine monitor 252, can control each virtual machine 254, 255. The user's use OS (guest OS) 402, 404 includes an agent 402A, 404A. Like the agent 116A in the virtual machine 114 of the rich client terminal 11, the agent 402A, 404A is a program which executes a process of enabling cooperation between the system 1 and each thin client terminal 12 (i.e. each virtual machine 254, 255 which communicates with the thin client terminal 12).

The connection broker 26 is applied to the client management system 1 in order to execute, e.g. management of user profiles. The connection broker 26 may be realized by a physical server.

The connection broker 26 manages a plurality of user profiles by using the profile storage 27 which stores a plurality of user profiles corresponding to a plurality of users. In addition, the connection broker 26 has a function for allocating an available virtual machine on the thin client execution server 25 to the user who has executed a logon operation on the thin client terminal 12. Furthermore, the connection broker 26 has a function (roaming function) for enabling each user to use the same user environment, even when each user has executed a logon operation on any one of the client terminals.

The profile storage 27 stores many user profiles which are associated with identifiers (user IDs) of many users who can use the present system 1. Specifically, the profile storage 27 includes many storage areas for storing user profiles corresponding to many users. When a certain user has executed a logon operation for connecting (“logon”) a certain client terminal to the system 1, a user profile, which is associated with the user ID of this user, is automatically mounted on a file system of the virtual machine corresponding to this client terminal. For example, in the logon process of the rich client terminal 11, the user profile corresponding to the user, who has executed the logon operation, is mounted on a file system of the virtual machine 114 in the rich client terminal 11. The substance of the user profile (setup information, user data) does not exist in the local storage in the rich client terminal 11, and the substance of the user profile is managed in the system 1. Therefore, the security of the rich client terminal 11 can be enhanced.

On the other hand, in the logon process of the thin client terminal 12, the user profile associated with the user ID of the user, who has executed the logon operation, is automatically mounted on a file system of the virtual machine 254, 255 in the thin client execution server 25, which corresponds to this thin client terminal 12.

Thereby, each user can use the same user environment (the same user profile) even when each user has logged on to the system 1 by operating either the rich client terminal 11 or the thin client terminal 12.

The disk image storage 28 stores disk image files which have been generated by the disk image delivery server 24. Incidentally, each of the profile storage 27 and disk image storage 28 may be realized by a storage in a file server (not shown) in the system 1.

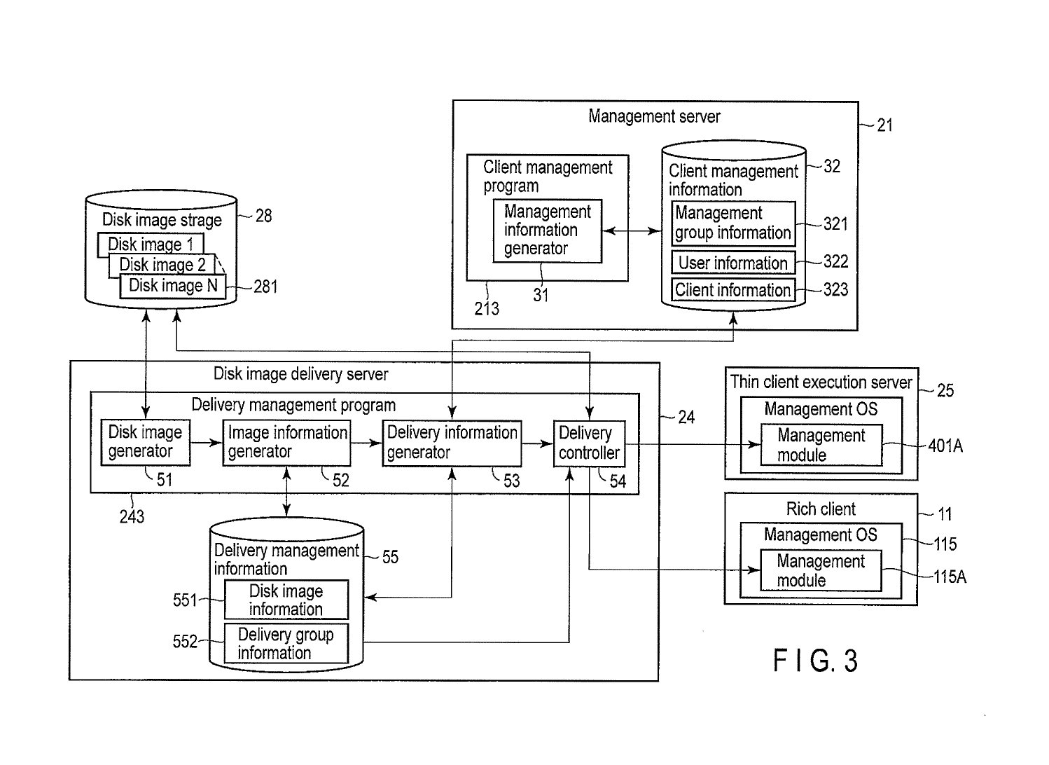

Next, referring to FIG. 3, a description is given of a functional configuration for the delivery of the disk image file 281 in the client management system 1.

The client management program 213, which is executed on the management server 21, includes a management information generator 31. The management information generator 31 generates client management information 32 in accordance with an operation from an administrator terminal (management console) connected to the LAN. The client management information 32 includes, for example, user information 322, client information 323 and management group information 321. The user information 322 is indicative of a user who can use the client management system 1. The client information 323 is indicative of a rich client terminal 11 which is connectable to the client management system 1. The management group information 321 is indicative of management groups to which the rich client terminals 11 and users may belong.

Using the user information 322, client information 323 and management group information 321, the management server 21 can manage rich client terminals 11 and users in association with a plurality of management groups which are hierarchically organized.

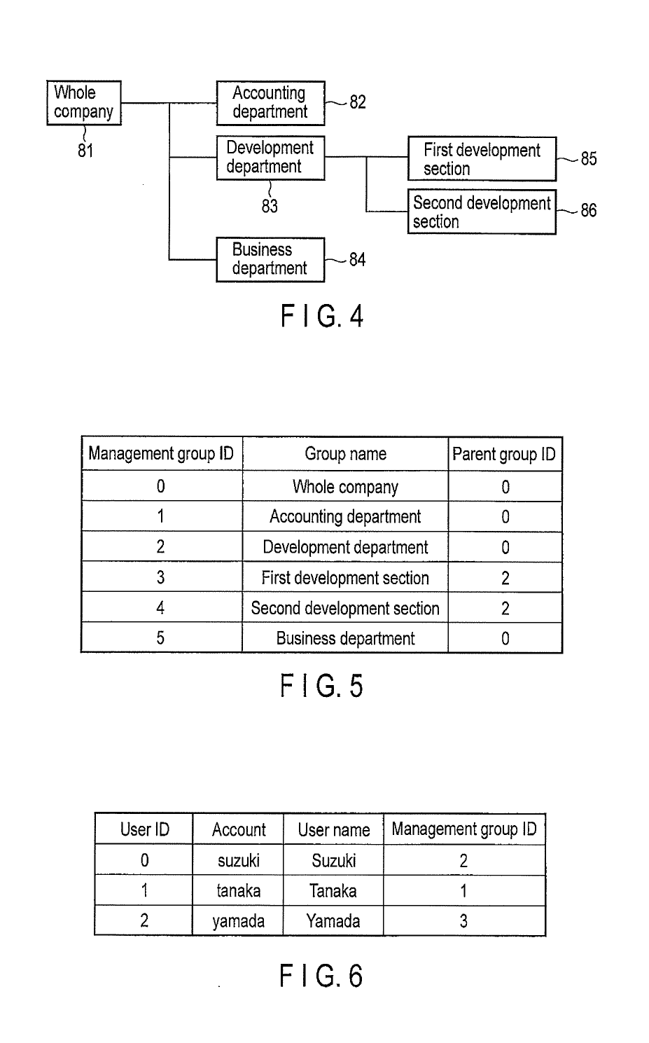

FIG. 4 shows examples of management groups which are hierarchically organized, as in the case of a hierarchical structure of departments/sections in a company. In the hierarchic groups (hereinafter also referred to as “group tree”), a “child” management group may be set for a “parent” management group which is an upper-layer group. In the example shown in FIG. 4, with a “whole company” group 81 being set as a “parent”, three “child” groups, namely an “accounting department” group 82, a “development department” group 83 and a “business department” group 84, are set. In addition, with the “development department” group 83 being set as a “parent”, two “child” groups, namely a “first development section” group 85 and a “second development section” group 86, are set.

FIG. 5 illustrates a configuration example of the management group information 321 which is generated by the management information generator 31. The management group information 321 includes a plurality of entries corresponding to a plurality of management groups. Each entry includes, for example, a management group ID, a group name, and a parent group ID. In an entry corresponding to a certain management group, “Management group ID” is indicative of identification information which is given to the management group. “Group name” is indicative of the name of the group. “Parent group ID” is indicative of a group ID which is given to a “parent” management group of this management group (i.e. a group ID of an upper-layer management group to which the management group is subordinate).

In addition, FIG. 6 illustrates a configuration example of the user information 322 which is generated by the management information generator 31. The user information 322 includes a plurality of entries corresponding to a plurality of users. Each entry includes, for example, a user ID, an account, a user name and a management group ID. In an entry corresponding to a certain user, “User ID” is indicative of identification information which is given to the user. “Account” is indicative of an account which is given to the user. For this account, for example, use is made of a character string including an alphabetic character, a numeral, a predetermined symbol, etc. “User name” is indicative of the name of. the user. “Management group ID” is indicative of the ID of a management group to which the user belongs. Accordingly, in the “Management group ID”, the management group ID of any one of the entries in the management group information 321 is set.

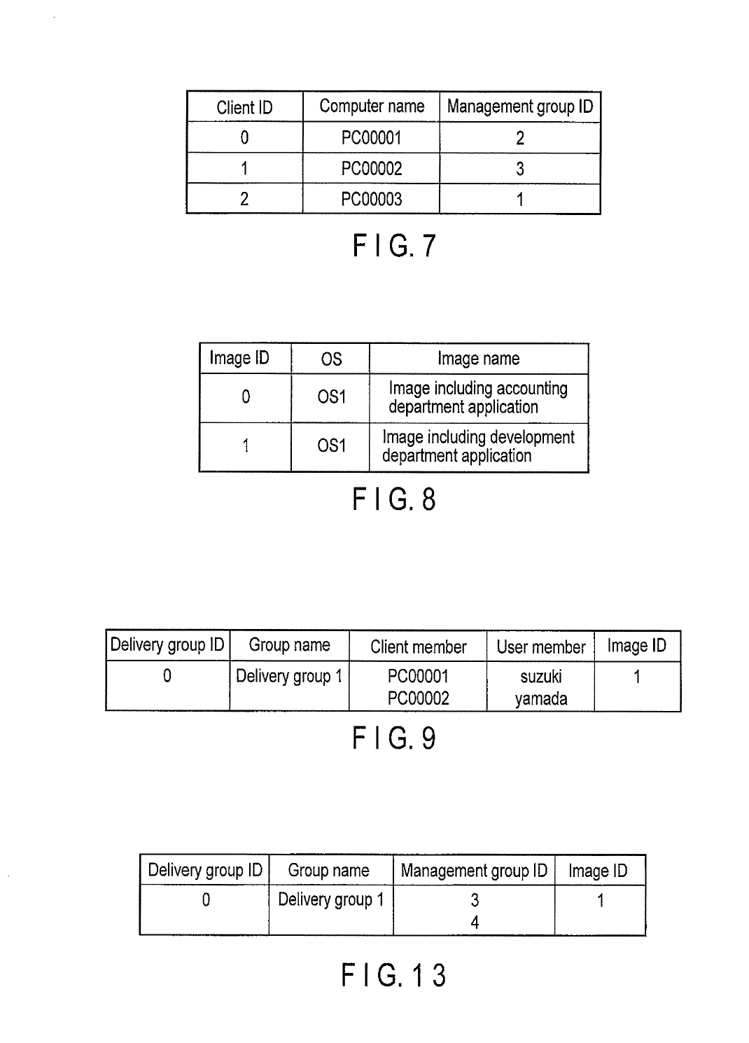

FIG. 7 illustrates a configuration example of the client information 323 which is generated by the management information generator 31. The client information 323 includes a plurality of entries corresponding to a plurality of rich client terminals 11. Each entry includes, for example, a client ID, a computer name, and a management group ID. In an entry corresponding to a certain rich client terminal, “Client ID” is indicative of identification information which is given to the rich client terminal. “Computer name” is indicative of a name given to the rich client terminal. “Management group ID” is indicative of a management group ID of a group to which the rich client terminal belongs. Accordingly, in the “Management group ID”, the management group ID of any one of the entries in the management group information 321 is set.

The management information generator 31 generates the above-described client management information 32, for example, in accordance with an operation from the administrator terminal. In the meantime, the management information generator 31 may alter or delete the generated client management information 32 in accordance with an operation from the administrator terminal.

Next, the delivery management program 243, which is executed on the disk image delivery server 24, is described.

The delivery management program 243, which is executed on the disk image delivery server 24, includes a disk image generator 51, an image information generator 52, a delivery information generator 53, and a delivery controller 54. The delivery management program 243 can execute, for example, management of delivery of the disk image 281, in accordance with an operation from the administrator terminal (not shown) which is connected to the LAN.

The disk image generator 51 generates a disk image file 281, which is used in at least one of the rich client terminal 11 and thin client execution server 25. The disk image generator 51 generates, for example, the disk image file 281 including the OS and application which are designated by the administrator. The disk image generator 51 generates the disk image file 281, for example, by making use of a virtual machine in the disk image delivery server 24, or a virtual machine in some other server. The virtual machine is realized, for example, by using Hyper-V or VMware®. In addition, the disk image generator 51 may generate the disk image file 281 by making use of a client terminal in which the OS and application program are actually installed. The disk image generator 51 stores the generated disk image file 281 in the disk image storage 28. In the meantime, the disk image generator 51 may store the generated disk image 281, for example, in the storage device provided in the disk image delivery server 24.

In response to the generation of the disk image file 281, the image information generator 52 generates disk image information 551 corresponding to this disk image file 281. Specifically, the image information generator 52 generates an entry corresponding to the disk image file 281, and adds the entry to the disk image information 551.

FIG. 8 illustrates a configuration example of the disk image information 551. The disk image information 551 includes a plurality of entries corresponding to a plurality of disk images 281. Each entry includes an image ID, an OS and an image name. In an entry corresponding to a certain disk image, “Image ID” is indicative of identification information which is given to the disk image. “OS” is indicative of the name of the OS which is included in the disk image. “Image name” is indicative of the name which is given to the disk image. For the “Image name”, for example, a name (e.g. “Image including accounting department application”) indicative of a target, to which the disk image is delivered, is set.

The delivery information generator 53 generates delivery group information 552 which is indicative of a delivery group to which the generated disk image 281 is delivered. For example, the rich client terminal 11 and the user, who uses the thin client terminal 12, belong to the delivery group. Specifically, by the delivery group information 552, the rich client terminal 11 and the user, who uses the thin client terminal 12, are associated with a certain disk image 281. On the virtual machine 114 of the rich client terminal 11 which is associated with the disk image 281, the OS and application program in this disk image 281 are executed. In addition, by using this disk image 281, the user associated with the disk image 281 can use, via the thin client terminal 12, the OS and application program which are executed on the virtual machine 254 of the thin client execution server 25.

FIG. 9 illustrates a configuration example of the delivery group information 552. The delivery group information 552 includes a plurality of entries corresponding to a plurality of delivery groups. Each entry includes, for example, a delivery group ID, a group name, a client member, a user member, and an image ID. In an entry corresponding to a certain delivery group, “Delivery group ID” is indicative of identification information which is given to the delivery group. “Delivery group name” is indicative of the name of the delivery group. “Client member” is indicative of the computer name of the rich client terminal 11 belonging to the delivery group. In the meantime, for the “Client member”, the client ID of the rich client terminal 11 belonging to the delivery group may be set. “User member” is indicative of the account of the user belonging to the delivery group. Incidentally, for the “User member”, the user ID of the user belonging to the delivery group may be set. “Image ID” is indicative of the image ID of the disk image which is delivered to the delivery group.

Accordingly, in the entry of the delivery group information 552 illustrated in FIG. 9, it is specified that a disk image 281 whose image ID is “1” (“image including development department application” in the disk image information 551 shown in FIG. 8) is delivered to rich client terminals “PC0001” and “PC0002” which are client members, and that users “suzuki” and “yamada” who are user members can use this disk image 281 (“image including development department application”) via the thin client terminal 12.

The delivery information generator 53 displays, for example, a delivery group setup screen for setting a delivery group, and a delivery image setup screen for setting the disk image 281 that is delivered to the delivery group. The delivery information generator 53 generates the above-described delivery group information 552 in accordance with an input using these screens.

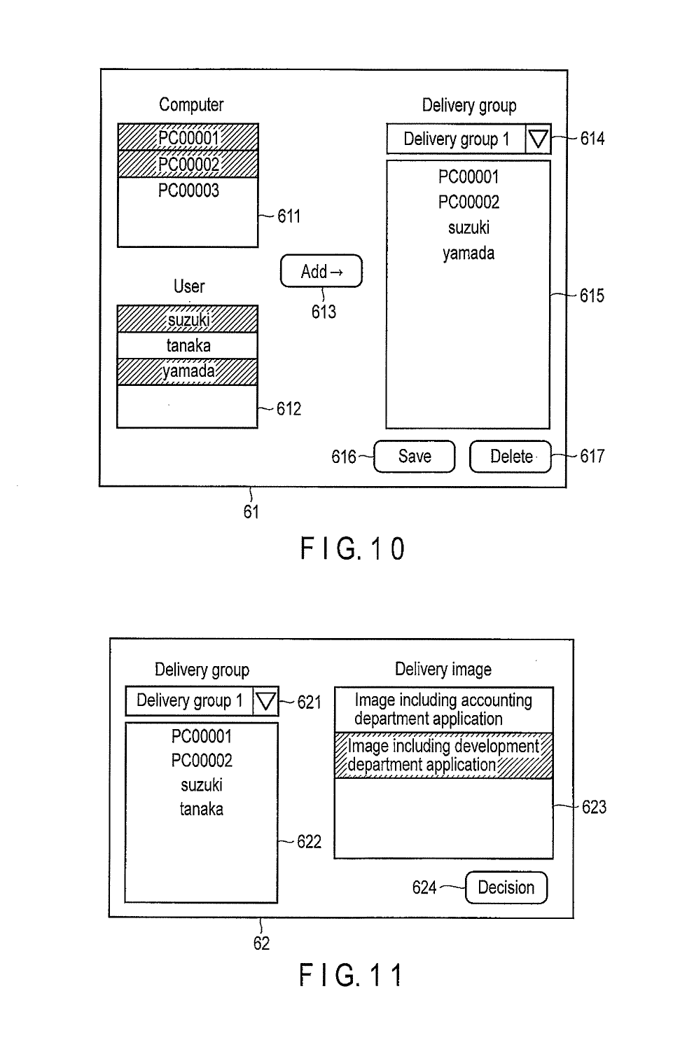

FIG. 10 illustrates an example of the delivery group setup screen displayed by the delivery information generator 53. A delivery group setup screen 61 includes, for example, a client select area 611, a user select area 612, an add button 613, a delivery group select button 614, a member area 615, a save button 616, and a delete button 617.

In the client select area 611, button indicative of rich client terminals 11 are disposed. The buttons in the client select area 611 are indicative of, for example, rich client terminals 11 corresponding to the respective entries of the client information 323. In the user select area 612, buttons indicative of users are disposed. The buttons in the user select area 612 are indicative of, for example, users corresponding to the respective entries of the user information 322. The delivery group select button 614 is a button for selecting a delivery group which is a target of setup. In the meantime, the delivery group select button 614 can be also used as a text input area for inputting the name of a new delivery group. The member area 615 is an area which displays members that are to be made to belong to the delivery group selected by using the delivery group select button 614.

The add button 613 is a button for adding to the member area 615 the rich client terminal 11 corresponding to the button, which is set in a selected state in the client select area 611, and the user corresponding to the button, which is set in a selected state in the user select area 612. Specifically, in the member area 615, responding to the pressing (selecting) of the add button 613, the rich client terminal 11 corresponding to the button in a selected state in the client select area 611, and the user corresponding to the button in a selected state in the user select area 612, are displayed.

The save button 616 is a button for saving the members of the set delivery group as the delivery group information 552. In addition, the delete button 617 is a button for deleting, from the delivery group, a member that is set in a selected state, among the members (rich client terminals or users) displayed in the member area 615.

In addition, FIG. 11 illustrates an example of the delivery image setup screen displayed by the disk image delivery server 24. A delivery image setup screen 62 includes, for example, a delivery group select button 621, a member display area 622, a delivery image select area 623, and a decision button 624.

The delivery group select button 621 is a button for selecting a delivery group that is a target of setup. The member area 622 is an area which displays members belonging to the delivery group, which has been selected by using the delivery group select button 621. In the delivery image select area 623, buttons corresponding to disk images 281, which can be delivered, are disposed based on the disk image information 551.

Using the above-described delivery group setup screen 61 and delivery image setup screen 62, the administrator executes an operation for associating a delivery group, to which at least one of the rich client terminal 11 and user belongs, with a disk image 281 for this delivery group. For example, when the administrator is to set members of “Delivery group 1” by using the delivery group setup screen 61, the administrator sets, among the buttons displayed in the client select area 611, the buttons corresponding to the rich client terminals 11, to which the disk image 281 is to be delivered, in the selected state, and also sets, among the buttons displayed in the user select area 612, the buttons corresponding to the users, who use the disk image 281 via the thin client terminals 12, in the selected state. Then, by the administrator pressing the add button 613, the rich client terminals 11 and users, which are in the selected state, are added to the member area 615. Further, by the administrator pressing the save button 616, the delivery information generator 53 generates an entry of the delivery group information 552 in which the “Delivery group ID”, “Group name”, “Client member” and “User member” are set.

Subsequently, for example, when the administrator is to set the disk image 281, which is to be delivered to the “Delivery group 1”, by using the delivery image setup screen 62, the administrator sets, among the buttons displayed in the delivery image select area 623, the button corresponding to the disk image 281 (e.g. “Image including development department application”), which is to be delivered to the delivery group 1, in the selected state. Then, by the administrator pressing the decision button 624, the delivery information generator 53 sets the image ID of this disk image 281 (e.g. the image ID “1” corresponding to the “Image including development department application”) in the “Image ID” in the entry of the delivery group information 552 which corresponds to the “Delivery group 1”.

Based on the generated delivery group information 552, the delivery controller 54 controls the delivery of the disk image 281 to the rich client terminal 11 and thin client execution server 25. Specifically, the delivery controller 54 reads the entry of the delivery group information 552. The delivery controller 54 reads the disk image 281, which corresponds to the image ID that is set in the entry, from the disk image storage 28. Then, when client members are set in the entry, the delivery controller 54 delivers the read disk image 281 to each of the rich client terminals 11 which are set as the client members. In addition, when user members are set in the entry, the delivery controller 54 delivers the read disk image 281 and information (user member information) indicative of the user members to the thin client execution server 25. For example, in FIG. 9, the user member information is a list of user accounts including “suzuki” and “yamada”. In the meantime, the delivery controller 54 may convert the file format of the read disk image 281 (e.g. conversion from VHD format to VMDK format), and may deliver the disk image 281 of the converted format to the thin client execution server 25.

The management module 115A in the rich client terminal 11 receives the disk image 281 which has been delivered from the delivery controller 54. Thereby, on the virtual machine 114 of the rich client terminal 11, the OS and application program (desktop environment) in the disk image 281 are executed.

Besides, the management module 401A in the thin client execution server 25 receives the disk image 281 and the information indicative of the user member, which have been delivered from the delivery controller 54. The management module 401A executes such control that only the user set as the user members can use the OS and application program (desktop environment) in the disk image 281 by using the thin client terminal 12. For example, when the use of the thin client terminal 12 has been started, the management module 401A authenticates the user who uses this thin client terminal 12, and permits only the authenticated user (the user included in the above-described user members) to use the OS and application program in the disk image 281. In addition, the management module 401A prohibits a non-authenticated user (a user not included in the above-described user members) from using the OS and application program in the disk image 281. Thereby, the OS and application program in the delivered disk image 281 are executed on the virtual machine 254 of the thin client execution server 25, and the user who is set as the user member can use the OS and application program via the thin client terminal 12.

By the above-described configuration, the desktop environments of plural client terminals can be centrally managed, regardless of the kinds of client terminals. In the present embodiment, in order to manage the desktop environments of the client terminals 11 and 12, the disk image 281 including the OS and application program is delivered by the disk image delivery server 24. The disk image delivery server 24 delivers the disk image 281 to the rich client terminal 11 belonging to the delivery group, and the thin client execution server 25. Thereby, the OS and application program (desktop environment) included in one disk image 281 can be used from the respective client terminals 11 and 12, regardless of the kinds of terminals, namely the rich client terminal 11 and thin client terminal 12. Therefore, the desktop environments of the client terminal 11 and thin client terminal 12 can centrally be managed by using the common disk image 281.

In the meantime, in many cases, the disk image 281 is generated in association with each of management group units, such as departments/sections in a company. Thus, management groups may be set as members of a delivery group for the delivery of the disk image 281. In the method in which management groups are set as members of a delivery group, when a user or a rich client terminal 11 is to be added, the delivery of the disk image 281 can be controlled by simply setting the management group to which the user or rich client terminal 11 belongs.

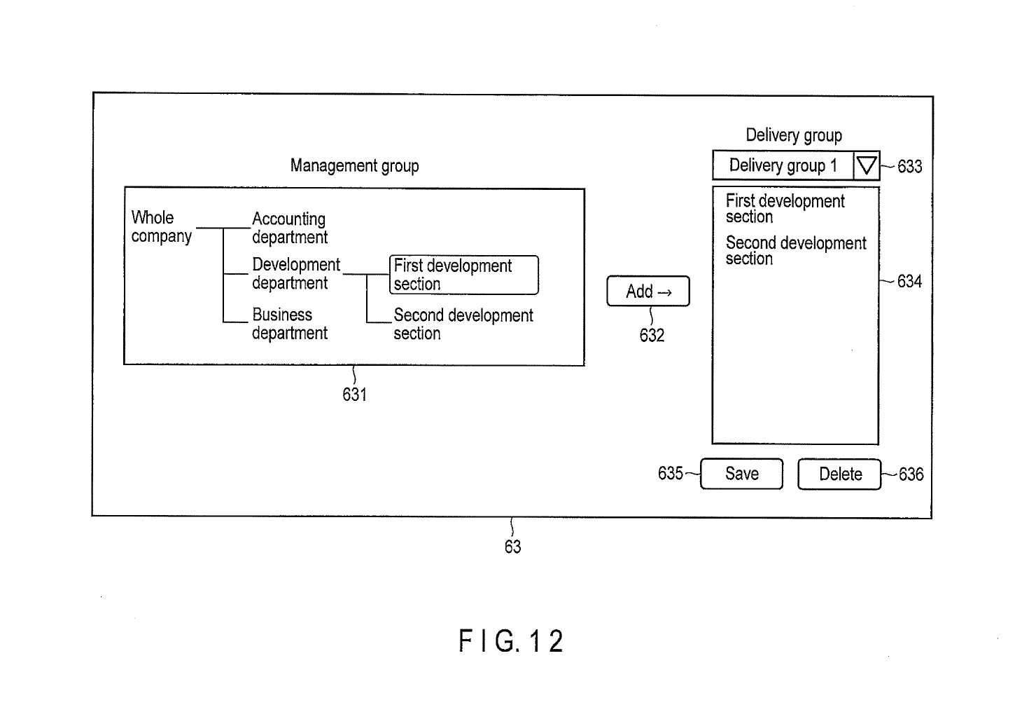

FIG. 12 illustrates another example of the delivery group setup screen displayed by the delivery information generator 53. In a delivery group setup screen 63, a management group can be set as a member of a delivery group. The delivery group setup screen 63 includes, for example, a management group select area 631, an add button 632, a delivery group select button 633, a member area 634, a save button 635, and a delete button 636. In the management group select area 631, with use of the management group information 321, buttons corresponding to management groups are arranged based on the hierarchical structure of management groups.

The administrator performs an operation for setting the delivery group by using the delivery group setup screen 63. For example, when the administrator is to set members of “Delivery group 1”, the administrator sets, among the buttons displayed in the management group select area 631, the button corresponding to the management group (e.g. “first development section”), to which the disk image 281 is to be delivered, in the selected state. Then, by the administrator pressing the add button 632, the management group in the selected state is added to the member area 634. Further, by the administrator pressing the save button 635, the delivery information generator 53 generates an entry of the delivery group information 552 in which the “Delivery group ID”, “Group name” and “Management group ID” are set.

FIG. 13 illustrates a structure example of the delivery group information 552 in which management groups are set as members of a delivery group. The delivery group information 552 includes a plurality of entries corresponding to a plurality of delivery groups. Each entry includes, for example, a delivery group ID, a group name, a management group ID, and an image ID. In an entry corresponding to a certain delivery group, “Delivery group ID” is indicative of identification information which is given to the delivery group. “Group name” is indicative of the name of the delivery group. “Management group ID” is indicative of the ID of a management group belonging to the delivery group. “Image ID” is indicative of the image ID of the disk image 281 which is delivered to the delivery group.

Using the delivery group information 552, the delivery controller 54 delivers an associated disk image 281 to each delivery group. Specifically, the delivery controller 54 reads the entry of the delivery group information 552, and reads the disk image 281, which corresponds to the image ID set in the entry, from the disk image storage 28. Then, using the user information 322 and client information 323 in the management server 21, the delivery controller 54 detects the user and the rich client terminal 11, which belong to the management group that is set in the entry. When the rich client terminal 11 belonging to the management group has been detected, the delivery controller 54 delivers the read disk image 281 to the detected rich client terminal 11. In addition, when the user belonging to the management group has been detected, the delivery controller 54 delivers the read disk image 281 and information indicative of the detected user to the thin client execution server 25. Thereby, on the virtual machine 114 of the rich client terminal 11 to which the disk image 281 has been delivered, the OS 116 and application program 117 in the disk image 281 are executed. In addition, on the virtual machine 254 of the thin client execution server 25, the OS 402 and application program 403 in the delivered disk image 281 are executed, and the user belonging to the above-described management group can use the OS 402 and application program 403 by using the thin client terminal 12.

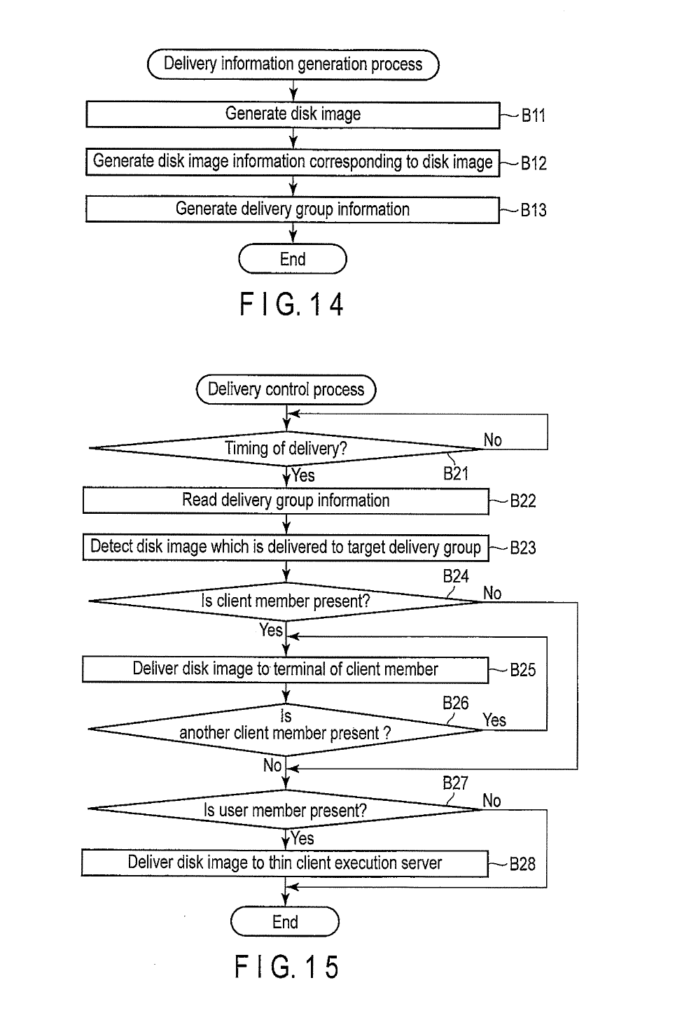

Next, referring to a flowchart of FIG. 14, a description is given of an example of the procedure of a delivery information generation process executed by the disk image delivery server 24.

To start with, the disk image generator 51 generates a disk image 281 for client terminals 11 and 12 (block B11). The disk image 281 is, for example, a disk image file including an OS and an application program, which are used on the client terminals 11 and 12. The disk image generator 51 stores the generated disk image 281 in the disk image storage 28.

The image information generator 52 generates disk image information 551 corresponding to the generated disk image 281 (block B12). Specifically, the image information generator 52 generates an entry corresponding to the disk image file 281, and adds the entry to the disk image information 551.

The delivery information generator 53 generates delivery group information 552 indicative of a delivery group to which the generated disk image 281 is delivered (block B13). The delivery information generator 53 generates an entry including information indicative of the rich client terminal 11 in which the generated disk image 281 is used, and the user who uses the disk image 281 via the thin client terminal 12, for example, in accordance with an input using the delivery group setup screen 61, 63. The delivery information generator 53 then adds the entry to the delivery group information 552.

FIG. 15 is a flowchart illustrating an example of the procedure of a delivery control process executed by the disk image delivery server 24.

To start with, the delivery controller 54 determines whether a timing at which the disk image 281 is delivered has come (block B21). For example, when the generation of the delivery group information 552 has been completed, the delivery controller 54 determines that a timing at which the disk image 281 is delivered has come. In the meantime, the delivery controller 54 may determine that a timing at which the disk image 281 is delivered has come, when the disk image 281 has been altered, when the members belonging to the delivery group have been altered, or when the delivery of the disk image 281 has been requested from the rich client terminal 11 or thin client terminal 12 (i.e. the thin client execution server 25). When a timing at which the disk image 281 is delivered has not come (NO in block B21), the process returns to block B21, and it is determined once again whether a timing at which the disk image 281 is delivered has come.

On the other hand, when a timing at which the disk image 281 is delivered has come (YES in block B21), the delivery controller 54 reads the delivery group information 552 (block B22). For example, the delivery controller 54 successively reads entries included in the delivery group information 552.

Based on the read entry of the delivery group information 552, the delivery controller 54 detects the disk image 281, which is to be delivered to the target delivery group, from the disk image storage 28 (block B23).

Then, the delivery controller 54 determines whether a client member is set in the read entry of the delivery group information 552 (block B24). If a client member is not set (NO in block B24), the process advances to block B27.

On the other hand, if a client member is set (YES in block B24), the disk image 281 detected in block B23 is delivered to the rich client terminal 11 which is set as the client member (block B25). Then, the delivery controller 54 determines whether another client member is set in the read entry of the delivery group information 552 (block B26). When another client member is set (YES in block B26), the process returns to block B25, and the disk image 281 is delivered to this client member (rich client terminal 11). When another client member is not set (NO in block B26), the process advances to block B27.

Incidentally, when a delivery request has been issued from a client, the disk image 281 may be delivered to all clients indicated in the delivery group information 552, or may be delivered to only the client which has issued the delivery request.

Subsequently, the delivery controller 54 determines whether a user member is set in the read entry of the delivery group information 552 (block B27). If a user member is set (YES in block B27), the delivery controller 54 delivers to the thin client execution server 25 the disk image 281 detected in block B23 and a list of user members (block B28).

By the above-described process, the delivery controller 54 can control the delivery of the disk image 281 in association with each of delivery groups, based on each entry in the delivery group information 552.

As has been described above, according to the present embodiment, the desktop environments of plural client terminals can be centrally managed, regardless of the types of client terminals. In order to manage the desktop environments of the rich client terminal 11 and thin client terminal 12, the disk image delivery server 24 delivers the disk image 281 including the OS and application program. The disk image delivery server 24 delivers the disk image 281 to the rich client terminal 11 which belongs to the delivery group, and also delivers the disk image 281 to the thin client execution server 25 in which the virtual machine that communicates with the thin client terminal 12 by using the screen transfer protocol is executed. When a user belonging to the delivery group uses the thin client terminal 12, the thin client execution server 25 permits the use of the OS and application program included in the disk image 281. Thereby, the OS and application program (desktop environment) included in one disk image 281 can be used from the respective client terminals 11 and 12, regardless of the types of terminals, namely the rich client terminal 11 and thin client terminal 12. Therefore, even in the system in which the client terminal 11 and thin client terminal 12 are mixedly present, the desktop environments of these client terminals 11 and 12 can centrally be managed by using the common disk image 281.

All the process procedures of this embodiment, which have been described with reference to the flowcharts of FIGS. 14 and 15, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus applied to a client management system which is configured to manage first-type client terminals and second-type client terminals on a network, the apparatus comprising:
a file generator configured to generate a disk image file comprising an operating system and an application program;
an information generator configured to generate delivery group information comprising at least one of client member information and user member information, wherein the client member information indicates a first terminal of the first-type client terminals, the first terminal is configured to execute virtualization software and the operating system and the application program in the disk image file, and the user member information indicates a user who uses the operating system and the application program by using any one of the second-type client terminals; and
a delivery controller configured to deliver the disk image file to the first terminal if the client member information is included in the delivery group information, and to deliver the disk image file to an execution server if the user member information is included in the delivery group information, wherein the execution server is configured to execute a virtual machine configured to communicate with each of the second-type client terminals by using a screen transfer protocol.

2. The information processing apparatus of claim 1, wherein the execution server is configured to execute the operating system and the application program on the virtual machine by using the delivered disk image file, when the user uses any one of the second-type client terminals.

3. The information processing apparatus of claim 1, wherein the delivery controller is configured to further transmit the user member information to the execution server, and
the execution server is configured to receive the user member information, and to execute the operating system and the application program on the virtual machine by using the delivered disk image file, when the user indicated in the user member information uses any one of the second-type client terminals.

4. A client management method of managing first-type client terminals and second-type client terminals on a network, comprising:
generating a disk image file comprising an operating system and an application program;
generating delivery group information comprising at least one of client member information and user information, wherein the client member information indicates a first terminal of the first-type client terminals, the first terminal is configured to execute virtualization software and the operating system and the application program in the disk image file, and the user member information indicates a user who uses the operating system and the application program by using any one of the second-type client terminals; and
delivering the disk image file to the first terminal if the client member information is included in the delivery group information, and delivering the disk image file to an execution server if the user member information is included in the delivery group information, wherein the execution server is configured to execute virtual machine configured to communicate with each of the second-type client terminals by using a screen transfer protocol.

5. The client management method of claim 4, wherein the execution server is configured to execute the operating system and the application program on the virtual machine by using the delivered disk image file, when the user uses any one of the second type client terminals.

6. The client management method of claim 4, wherein the delivering further comprises transmitting the user member information to the execution server, and
the execution server is configured to receive the user member information, and to execute the operating system and the application program on the virtual machine by using the delivered disk image file, when the user indicated in the user member information uses any one of the second-type client terminals.

7. A computer-readable, non-transitory storage medium having stored thereon a program which is executable by a computer and causes the computer to manage first-type client terminals and second-type client terminals on a network, the program controlling the computer to execute functions of:
generating a disk image file comprising an operating system and an application program;
generating delivery group information comprising at least one of client member information and user member information, wherein the client member information indicates a first terminal of the first-type client terminals, the first terminal is configured to execute virtualization software and the operating system and the application program in the disk image file, and the user member information indicates a user who uses the operating system and the application program by using any one of the second-type client terminals; and
delivering the disk image file to the first terminal if the client member information is included in the delivery group information, and delivering the disk image file to an execution server if the user member information is included in the delivery group information, wherein the execution server is configured to execute a virtual machine configured to communicate with each of the second-type client terminals by using a screen transfer protocol.

8. The storage medium of claim 7, wherein the execution server is configured to execute the operating system and the application program on the virtual machine by using the delivered disk image file, when the user uses any one of the second-type client terminals.

9. The storage medium of claim 7, wherein the delivering further comprises transmitting the user member information to the execution server, and
the execution server is configured to receive the user member information, and to execute the operating system and the application program on the virtual machine by using the delivered disk image file, when the user indicated in the user member information uses any one of the second-type client terminals.
